(19) United States
(12) Patent Application Publication
(10) Pub. No.: US 2025/0173893 A1
(43) Pub. Date: May 29, 2025

(54) ELECTRONIC DEVICE FOR DETECTING GAZE OF USER AND OPERATING METHOD THEREOF

(71) Applicant: ELECTRONICS AND TELECOMMUNICATIONS RESEARCH INSTITUTE, Daejeon (KR)

(72) Inventors: Ho Won KIM, Seoul (KR); Hye-sun KIM, Daejeon (KR); Chang Joon PARK, Daejeon (KR)

(21) Appl. No.: 18/941,953

(22) Filed: Nov. 8, 2024

(30) Foreign Application Priority Data
Nov. 24, 2023 (KR) 10-2023-0165629
Apr. 25, 2024 (KR) 10-2024-0055588

(51) Int. Cl. G06T 7/73

(52) U.S. Cl. CPC G06T 7/73; G06T 2207/20081; G06T 2207/20084; G06T 2207/30201

(57) ABSTRACT

The operating method includes: acquiring an image including a person; extracting a normalized image including a face of the person from the image; extracting feature information about the face from the normalized image; outputting, based on the feature information, pose information represented in a camera coordinate system which is a coordinate system of a camera acquiring the image and first gaze information represented in a facial coordinate system which is a coordinate system of the face; and determining, based on the pose information and the first gaze information, second gaze information represented in the camera coordinate system that includes a second unit vector from an origin of the facial coordinate system toward a gaze target represented in the camera coordinate system.

### CROSS-REFERENCE TO RELATED APPLICATIONS

This application claims the benefit under 35 USC § 119(a) of Korean Patent Application No. 10-2023-0165629 filed on Nov. 24, 2023, and Korean Patent Application No. 10-2024-0055588 filed on Apr. 25, 2024, in the Korean Intellectual Property Office, the entire disclosures of which are incorporated herein by reference for all purposes.

### BACKGROUND

### 1. Field of the Invention

The following description relates to an electronic device for detecting a gaze of a user and an operating method of the electronic device and, more particularly, to a personalized gaze detection method through correction based on eye features of an individual.

### 2. Description of Related Art

A method of detecting a gaze direction of a user may include a method using a specific-purpose camera combination and a method based on a deep learning model.

The specific-purpose camera combination may primarily use an infrared lighting unit and a stereo camera including two infrared cameras. The method using this specific-purpose camera combination may use the infrared reflective properties of the pupils to detect a gaze direction through triangulation between pupil positions in two images. This method may be used to track a gaze position within a monitor of a user who gazes at the monitor with the position and pose that are fixed as a range of motion (or simply a “motion range” herein) is limited at a time when a system is designed depending on a combination of the intensity of the light source and the distance between the cameras of the stereo camera. In other words, this method may have fundamental limitations when applied to users moving unrestrictedly.

The deep learning-based method, which is a typical method, may include methods of detecting a gaze direction toward a space of a user by receiving a color image, as an input, from a single camera, most of which may target a face that faces forward. This method may include learning and inferring a gaze direction through deep learning and artificial intelligence (AI) inference based on a camera coordinate system using eye or facial features such as pupil position, eyeline shape, and face shape.

To define a gaze direction used by the deep learning-based method, the method may require three-dimensional (3D) position information of a gaze target and 3D position information of eyes of a user, based on the camera coordinate system. The method may define and use, as a gaze direction, a unit vector from a 3D position of the eyes toward a 3D position of the gaze target. The 3D position of the gaze target may be defined relatively accurately by using a position correction method for a camera and the gaze target in the process of generating training data for deep learning. However, since data on the 3D position of the eyes moving in a space is collected mostly using a method of detecting a 3D head pose of a face, the deep learning-based method may have limitations in terms of gaze detection precision, compared to the method using the special-purpose camera combination. However, since it uses only images captured by a single camera, it may be applied to a far wider allowable motion range of a user, and thus a growing number of studies on this has been conducted recently.

### SUMMARY

An aspect may provide an electronic device and method for detecting a gaze of a user using only one camera.

An aspect may provide an electronic device and method for personalized gaze detection with minimal correction without a limited range of motion (or simply a “motion range” herein) of a user.

According to an example embodiment, there is provided an operating method of an electronic device, the operating method including: acquiring an image including a person; extracting a normalized image including a face of the person from the image; extracting feature information about the face from the normalized image; outputting, based on the feature information, pose information represented in a camera coordinate system which is a coordinate system of a camera acquiring the image and first gaze information represented in a facial coordinate system which is a coordinate system of the face; and determining, based on the pose information and the first gaze information, second gaze information represented in the camera coordinate system that includes a second unit vector from an origin of the facial coordinate system toward a gaze target represented in the camera coordinate system. The pose information may include rotation information and position information about the face, and the first gaze information may include rotation a first unit vector represented by a rotation of eyes from the origin of the facial coordinate system toward the gaze target, in the facial coordinate system.

The outputting of the pose information represented in the camera coordinate system and the first gaze information represented in the facial coordinate system based on the feature information may include outputting the first gaze information based on the feature information and on a network that is trained to detect generalized first gaze information and correct the generalized first gaze information based on features of the eyes of the person.

The first gaze information may include the first unit vector that is corrected based on the features of the eyes of the person to be personalized for the person.

The second gaze information may include the second unit vector that is personalized for the person as the features of the eyes of the person are reflected.

The operating method may further include identifying a position of the face from the position information and detecting the gaze target along the second gaze information from the position of the face.

The operating method may further include outputting, based on the feature information, third gaze information including a generalized third unit vector from the origin of the facial coordinate system toward the gaze target, in the camera coordinate system.

The determining of the second gaze information may include selecting, based on the rotation information, one from the third gaze information and fourth gaze information including a personalized unit vector determined based on the pose information and the first gaze information, and determining the selected one to be the second gaze information.

The determining of the second gaze information may include determining the second gaze information by a weighted sum of the third gaze information and the fourth gaze information based on the rotation information, and the fourth gaze information may include the personalized unit vector determined based on the pose information and the first gaze information.

The operating method may further include acquiring data for training the network configured to correct the generalized first gaze information based on the features of the eyes of the person.

The acquiring of the data may include acquiring the third gaze information as the data by generating a plurality of areas for a pupil rotation range of the person based on the features of the eyes, and acquiring the data preferentially by assigning a weight to an area from which data is not acquired among the plurality of areas.

The acquiring of the data may include, for areas from which data is acquired redundantly among the plurality of areas, selecting one from the redundantly acquired data based on the features of the eyes.

According to an example embodiment, there is provided an operating method of an electronic device, the operating method including: acquiring an image including a person; extracting a normalized image including a face of the person from the image; extracting feature information about the face from the normalized image; outputting, based on the feature information, pose information represented in a camera coordinate system which is a coordinate system of a camera acquiring the image and first gaze information represented in a facial coordinate system which is a coordinate system of the face; outputting, based on the feature information, second gaze information represented in the camera coordinate system that includes a generalized unit vector from an origin of the facial coordinate system of the person toward a gaze target represented in the camera coordinate system; and determining third gaze information including a third unit vector from the origin of the facial coordinate system toward the gaze target, in the camera coordinate system, based on the pose information, the first gaze information, and the second gaze information. The pose information may include rotation information and position information about the face, and the first gaze information may include a first unit vector represented by a rotation of eyes from the origin of the facial coordinate system toward the gaze target, in the facial coordinate system.

According to an example embodiment, there is provided a non-transitory computer-readable storage medium storing instructions that, when executed by a processor, cause the processor to perform one of the methods described above.

According to an example embodiment, there is provided an electronic device including: a processor configured to acquire an image including a person; extract a normalized image including a face of the person from the image; extract feature information about the face from the normalized image; output, based on the feature information, pose information represented in a camera coordinate system which is a coordinate system of a camera acquiring the image and first gaze information represented in a facial coordinate system which is a coordinate system of the face; and determine, based on the pose information and the first gaze information, second gaze information represented in the camera coordinate system that includes a second unit vector from an origin of the facial coordinate system toward a gaze target represented in the camera coordinate system. The pose information may include rotation information and position information about the face, and the first gaze information may include a first unit vector represented by a rotation of eyes from the origin of the facial coordinate system toward the gaze target, in the facial coordinate system.

The processor may be configured to output the first gaze information based on the feature information and on a network that is trained to detect generalized first gaze information and correct the generalized first gaze information based on features of the eyes of the person.

The first gaze information may include the first unit vector that is corrected based on the features of the eyes of the person to be personalized for the person.

The second gaze information may include the second unit vector that is personalized for the person as the features of the eyes of the person are reflected.

The processor may be configured to identify a position of the face from the position information and detect the gaze target along the second gaze information from the position of the face.

The processor may be configured to output, based on the feature information, third gaze information including a generalized unit vector from the origin of the facial coordinate system toward the gaze target, in the camera coordinate system.

The electronic device may be configured to select, based on the rotation information, one from the third gaze information and fourth gaze information including a personalized unit vector determined based on the pose information and the first gaze information, and determine the selected one to be the second gaze information.

According to example embodiments of the present disclosure, using a single camera may detect a gaze of a person moving unrestrictedly in front of the camera.

According to example embodiments of the present disclosure, personalized gaze detection may be performed in real time based on unique eye features of a user.

### BRIEF DESCRIPTION OF THE DRAWINGS

FIG. 1 is a diagram illustrating an electronic device and gaze detection according to an example embodiment of the present disclosure.

FIGS. 2 through 4 are diagrams illustrating gaze information and correction according to an example embodiment of the present disclosure.

FIG. 5 is a diagram illustrating a method of acquiring a normalized image according to an example embodiment of the present disclosure.

FIG. 6 is a diagram illustrating a deep learning network according to an example embodiment of the present disclosure.

FIG. 7 is a diagram illustrating the acquisition of eye features according to an example embodiment of the present disclosure.

FIG. 8 is a diagram illustrating a deep learning network according to an example embodiment of the present disclosure.

FIG. 9 is a diagram illustrating a method of selecting data according to an example embodiment of the present disclosure.

FIG. 10 is a flowchart illustrating an operating method of an electronic device according to an example embodiment of the present disclosure.

### DETAILED DESCRIPTION

The following structural or functional descriptions of example embodiments are merely intended for the purpose of describing the example embodiments, and the example embodiments may be implemented in various forms. The example embodiments are not meant to be limited, but it is intended that various modifications, equivalents, and alternatives are also covered within the scope of the claims.

Various modifications may be made to the example embodiments. Here, the example embodiments are not construed as limited to the disclosure and should be understood to include all changes, equivalents, and replacements within the idea and the technical scope of the disclosure.

Although terms “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component, or intervening components may be present. As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof. The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

In addition, when describing the example embodiments with reference to the accompanying drawings, like reference numerals refer to like components, and a repeated description related thereto is omitted. In describing the example embodiments, where it is determined that a detailed description of the related art would unnecessarily obscure the essence of the example embodiments, such detailed description is omitted.

Hereinafter, the example embodiments will be described in detail with reference to the accompanying drawings.

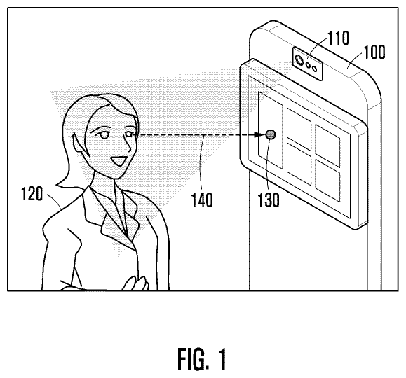

FIG. 1 is a diagram illustrating an electronic device and gaze detection according to an example embodiment of the present disclosure.

Referring to FIG. 1, shown is an electronic device 100 including a host processor (not shown), a memory (not shown), an accelerator (not shown), and a camera 110.

The host processor, the memory, the accelerator, and the camera 110 may communicate with each other via a bus, a network on a chip (NoC), a peripheral component interconnect express (PCIe), or the like. In FIG. 1, the electronic device 100 is shown as including only components deemed to be related to the example embodiments of the present disclosure. Accordingly, it is apparent to those skilled in the art that the electronic device 100 may include other general-purpose components in addition to those shown in FIG. 1.

The host processor may serve to perform overall functions for controlling the electronic device 100. The host processor may provide overall control of the electronic device 100 by executing programs and/or instructions stored in the memory and/or the accelerator. The host processor may be implemented as a central processing unit (CPU), a graphics processing unit (GPU), a neural processing unit (NPU), a tensor processing unit (TPU), a field-programmable gate array (FPGA), or the like, within the electronic device 100, but is not limited thereto.

The memory may be hardware that stores processed data and data to be processed within the electronic device 100. The memory may also store applications, drivers, or the like to be executed by the electronic device 100. The memory may include a volatile memory such as a dynamic random-access memory (DRAM), and/or a nonvolatile memory.

The electronic device 100 may include the accelerator for computation. The accelerator may perform operations that, due to the nature of the operations, are more efficiently performed on a separate dedicated host processor, i.e., an accelerator, rather than on a general-purpose host processor. In this case, the accelerator may use one or more processing elements (PEs) included in the accelerator. For example, the accelerator may correspond to a system on chip (SoC), an NPU, a GPU, or the like.

The electronic device 100 may include the camera 110. The camera 110 may capture still images and moving images (or videos). According to an example embodiment, the camera 110 may include one or more lenses, image sensors, image signal processors (ISPs), or flashes.

The operations described herein may be implemented with a processor including, but not limited to, the host processor and/or the accelerator.

The electronic device 100 may be a device capable of capturing images of a user 120 using the camera 110 and may include, as non-limiting examples, various computing devices such as a cellular phone, a smartphone, a tablet, an e-book device, a laptop, a personal computer (PC), a desktop, a workstation, or a server; various wearable devices such as a smartwatch, smart glasses, or a head-mounted display (HMD); various consumer electronics such as a smart speaker, a smart television (TV), or a smart refrigerator; and others such as a smart car, a smart kiosk, an Internet of Things (IoT) device, a walking assist device (WAD), a drone, or a robot.

The electronic device 100 may capture an image of the user 120 moving unrestrictedly in front of the camera 110. The electronic device 100 may acquire an image including a face of the user 120 through the camera 110. The electronic device 100 may determine, from the image, a gaze direction 140 of the user 120 with respect to a gaze target 130 (i.e., an object at which the user 120 gazes), such as, a specific position or a specific object. The electronic device 100 may determine the gaze direction 140 of the user 120 in real time through gaze correction based on features of eyes (or simply “eye features” herein) of the user 120 and through deep learning-based artificial intelligence (AI) inference. Herein, “eyes” may also refer to eyeballs.

The electronic device 100 may detect a gaze direction to a pixel position of a specific pixel included in a display of the electronic device 100, in addition to a gaze direction to a specific object in a space in which the user 120 is present. Atypical method of detecting the gaze direction 140 may detect the gaze direction 140 that is structurally constrained within the display, even though the user 120 gazes outside the display. Thus, the typical method of detecting the gaze direction 140 may not be able to determine whether the user 120 gazes into the display.

However, according to the present disclosure, the electronic device 100 may determine whether the user 120 gazes into the display. The electronic device 100 may identify a pixel at which the user 120 gazes when the user 120 gazes into the display and may identify a target present in a direction in the space at which the user 120 gazes when the user 120 gazes out of the display. In other words, when determining a gaze at a specific pixel in the display, the electronic device 100 may detect a three-dimensional (3D) gaze direction using deep learning-based AI inference, calculate an intersection point on a screen (e.g., the display) located in a space that intersects the 3D gaze direction starting from a 3D position of the eyes of the user 120, and calculate a position of a pixel on the screen using a planar transformation between a 3D plane and a two-dimensional (2D) screen plane. This method may be less precise than a typical 2D gaze detection method in detecting a position of a specific pixel at which the user 120 gazes, but may detect a gaze for the entire space in which the user 120 is present.

According to an example embodiment, the gaze direction 140 may be defined using 3D position information in a space of the gaze target 130 in a space relative to the camera 110 that acquires images in the electronic device 100 and 3D position information of the eyes in the space of the user 120. In this case, spatial positions of the camera 110 and the display may be structurally defined when designing the electronic device 100. Thus, a correlation between the camera 110 and the display may be predefined using spatial transformation information including a physical movement and rotation of the display relative to the camera 110. On the other hand, since the position of the eyes of the user 120 in front of the camera 110 may continuously change as the user 120 moves, it may be necessary to detect, from images input in real time, pose information of the face in the space of the user 120 and a gaze direction by a rotation of the eyes, to define the gaze direction 140 of the user 120.

In a case where the user 120 gazes at the gaze target 130 and the position of the gaze target 130 is known in advance, only the position of the eyes of the user 120 may be required to define the gaze direction 140. The typical method of detecting the gaze direction 140 using deep learning-based AI inference using a single face image of a user may detect a gaze direction (e.g., the gaze direction 140), using an image of a face of a user (e.g., the user 120) gazing at a gaze target (e.g., the gaze target 130) and a gaze direction defined by a position of eyes of the user and a position of the gaze target, without pose information of the face.

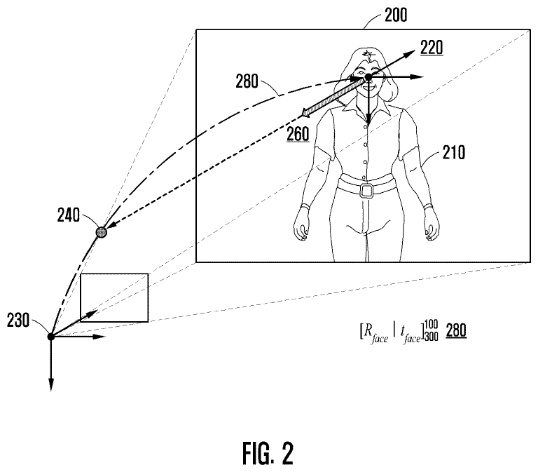

FIGS. 2 through 4 are diagrams illustrating gaze information and correction according to an example embodiment of the present disclosure.

Referring to FIG. 2, an image 200 including a user 210 gazing at a gaze target 240 is shown. The gaze target 240 described herein may refer to a 3D position represented in a camera coordinate system 230. Referring to FIG. 2, the camera coordinate system 230 and a facial coordinate system 220 are also shown. The camera coordinate system 230 may be based on a camera capturing an image of the user 210, and the facial coordinate system 220 may be based on a face of the user 210. In the present disclosure, according to an embodiment, the user 210 may be represented as a person or an individual.

According to an example embodiment, gaze information 260 may include a gaze direction of the user 120. The gaze information 260 may include a unit vector that reflects therein all correlations between spatial transformation information 280 between the camera coordinate system 230 and the facial coordinate system 220 and rotation information of the eyes for an actual gaze within the facial coordinate system 220. That is, the gaze information 260 may include a unit vector from an origin of the facial coordinate system 220 toward the gaze target 240 represented in the camera coordinate system 230. The spatial transformation information 280 may be pose information, which may be information indicative of a 3D position t_{face} and a 3D rotation R_{face} between the camera coordinate system 230 and the facial coordinate system 220.

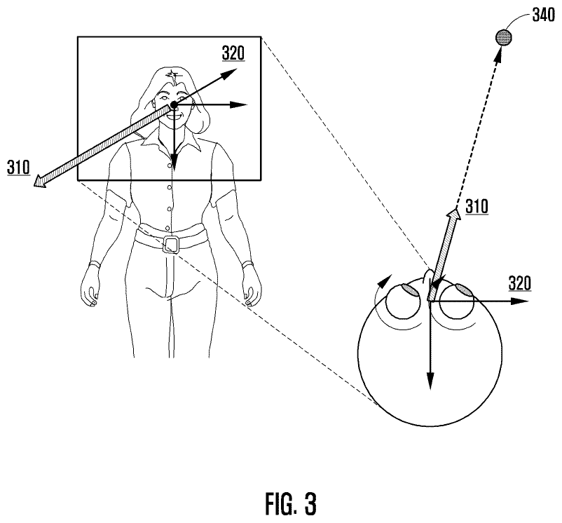

Referring to FIG. 3, shown is gaze information 310 including a unit vector represented by a rotation of eyes from an origin of a facial coordinate system 320 toward a gaze target 340 represented in the facial coordinate system 320, relative to the facial coordinate system 320. The gaze target 340 described herein may refer to a 3D position represented in the facial coordinate system 320. That is, the gaze information 310 may be independent of a movement of a face, as it includes the unit vector defined by the rotation of the eyes that occurs when a user gazes at the gaze target 340, in the facial coordinate system 320 independent of a movement of the face. Under the assumption that the gaze information 260 described above with reference to FIG. 2 and the gaze information 310 are defined as g_{cam} and g_{face}, respectively, a relationship between g_{cam} and g_{face} may be expressed as in Equation 1 below.

$${g}_{cam} = {R}_{face} \cdot {g}_{face} \qquad [ Equation 1 ]$$

In this case, rotating an eye direction by actual muscular contraction and/or relaxation and projecting light into eyes to acquire spatial information through optic nerves, based on features of eyes of an individual, may be limited to the gaze information 310. Thus, performing correction based on the features of the eyes may require correcting the gaze information 310 based on the features of the eyes.

That is, a typical deep learning-based gaze detection method using a single image may use, as a target to be corrected, the gaze information 260 in which the rotation information R_{face} of the face and the gaze information 310 are combined. A typical method of acquiring data for deep learning may perform deep learning to implicitly learn the rotation information R_{face} between the camera and the face and may thus detect a gaze without separate rotation information of the face. This typical approach may be effective in terms of process simplicity. However, in terms of correction, since a target of correction is the gaze information 260 in which the rotation information R_{face} of the face and the gaze information 310 are combined, which is a result of complexly applying rotation information of a face and actual rotation information of eyes from which a gaze is to be corrected, there may be a problem that gaze correction is required for more information than necessary.

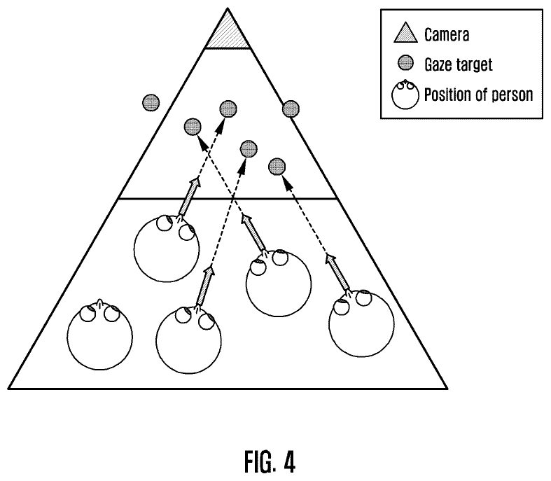

As a result, a training data set for gaze correction may be required to precisely correct a gaze while ensuring a free movement of a user, as shown in FIG. 4. In other words, the training data set for gaze correction may be required to enable a deep learning network to learn a correlation between the gaze information 310 defined based on the facial coordinate system 320 and the gaze information 260 defined based on the camera coordinate system 230, based on features of eyes of a user at various positions and poses of the user who moves unrestrictedly.

For example, even for a single user position, and even in a case where the user gazes at the same gaze target while varying a rotation of the face of the user, they may correspond to gaze information having the same unit vector. Thus, multiple training images or videos in which the rotation of the face varies and a gaze at a gaze target is maintained at each position of the user may be required to satisfy the correlation expressed in Equation 1. However, in terms of actual data acquisition for gaze correction, a monitor may be primarily used to ensure the diversity of positions of the gaze target and facilitate the collection of 3D position information of the gaze target, and accordingly a limited range may need to be assumed. As a result, to collect the data from a wider range of motion (or simply a “motion range” herein) of the user, the data acquisition process may require numerous movements of the user, which may not be user-friendly. Accordingly, in reality, only a small number of data acquired from a limited motion range of a user may be used for gaze correction, which may limit the precision of gaze correction and a stable motion range to be narrow.

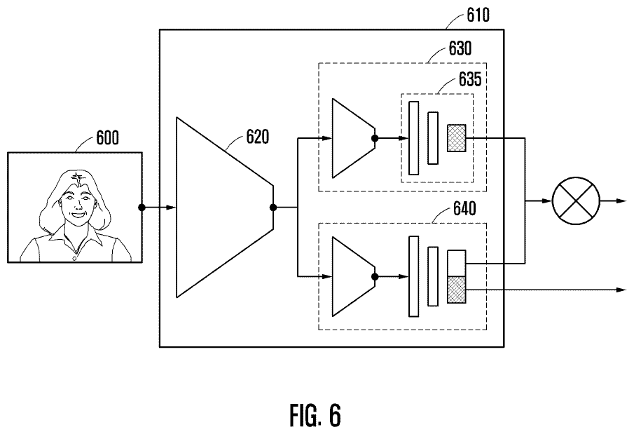

Hereinafter, gaze correction will be described in connection with a method of detecting the gaze information 260 by simultaneously detecting and combining the gaze information 310 and pose information including rotation information and position information about a face, as shown in FIG. 6.

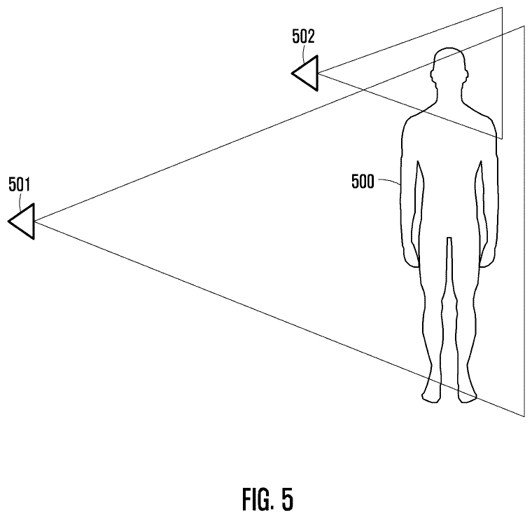

FIG. 5 is a diagram illustrating a method of acquiring a normalized image according to an example embodiment of the present disclosure.

An electronic device may extract a normalized image including a face of a user 500 from an image. The electronic device may extract the normalized image including the face using a virtual normalization camera 502. In this case, the electronic device may acquire the normalized image through a projection based on a perspective projection relative to a predefined coordinate system of the virtual normalization camera 502 located at a certain distance from the face, as opposed to a method of simply cropping an input image by area by an orthographic projection.

In this case, the normalization camera 502 may normalize a distance but not a rotation direction. This is because, if the normalization camera 502 normalizes the rotation direction, it may hinder the performance of training a deep learning model, and thus the trained deep learning model may exhibit a single operational characteristic to a specific rotation.

An input camera 501 may be an actual camera that captures an image of the user 500, which may be included in the electronic device. That is, the input camera 501 may have a variable distance or position with respect to the user 500.

Hereinafter, a method of detecting a gaze using a normalized image including a face of a user (e.g., the user 500) will be described.

FIG. 6 is a diagram illustrating a deep learning network according to an example embodiment of the present disclosure.

Referring to FIG. 6, shown is a deep learning network 610 that receives, as an input, a normalized image 600 including a face of a user. The deep learning network 610 may include a backbone network 620 and may further include networks that output pose information and gaze information based on feature information output from the backbone network 620. However, the deep learning network 610 shown in FIG. 6 is provided only as an example, and example embodiments of the present disclosure are not limited thereto.

The backbone network 620 may be a network trained to extract the feature information about the face of the user in response to the input of the normalized image 600. An electronic device may input the normalized image 600 to the backbone network 620 and the backbone network 620 may then extract the feature information about the face in response to the input of the normalized image 600.

The electronic device may input the feature information extracted from the backbone network 620 into each of a first network 630 and a second network 640. The first network 630 may output first gaze information (e.g., the gaze information 310 of FIG. 3) in response to the input of the feature information. The first gaze information may include a first unit vector represented by a rotation of eyes from an origin of a facial coordinate system to a gaze target, in the facial coordinate system. The second network 640 may output pose information about the face, which is based on a camera coordinate system, in response to the input of the feature information. The pose information may include rotation information and position information about the face.

In this case, the pose information may be based on an outer shape of the face and may be inferred independently of eye features of an individual. Accordingly, according to an example embodiment, a target of gaze correction may be limited to the first gaze information output from the first network 630. To this end, the deep learning network 610 may be configured to simultaneously infer the first gaze information and the pose information. The second network 640 may be a network trained to reliably and accurately output the pose information, independent of the position and pose of the user. Similarly, the first network 630 may be a network trained to reliably and accurately detect gaze information by a rotation of the eyes that is based on the facial coordinate system, independent of the pose of the face.

The first network 630 may include networks that directly and regressively infer the gaze information based on the feature information about the face extracted from the backbone network 620. Only on a network 635 of the networks shown in FIG. 6, gaze correction that reflects unique eye features of an individual may be performed. In other words, the first gaze information output from the first network 630 may be the gaze information acquired as the correction has been performed based on eye features of an individual. As a result, the first gaze information may include the first unit vector that is corrected based on eye features of a person to be personalized for the person.

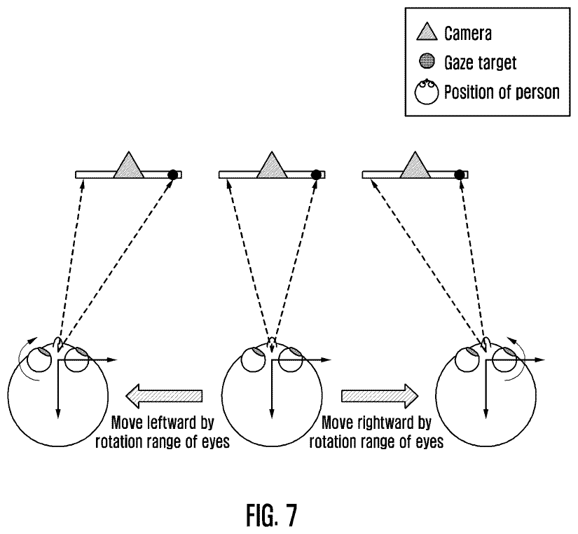

Since the first gaze information is determined by a direct rotation of the eyes, collecting training data for gaze correction may also be significantly simplified compared to the collection method for typical gaze correction described above with reference to FIG. 4. This will be described in detail below with reference to FIG. 7.

Based on the pose information and the first gaze information, the electronic device may determine second gaze information including a second unit vector from the origin of the facial coordinate system of the face of the user to the gaze target, in a camera coordinate system of a camera acquiring the image. In other words, the electronic device may determine the second gaze information by combining the first gaze information and the rotation information about the face. Since the first gaze information is information corrected based on eye features of a person, the second gaze information acquired based on the first gaze information may also include the second unit vector that is personalized for the person, as the eye features of the person are reflected.

The electronic device may identify a position of the face from the position information included in the pose information and may detect the gaze target from the position of the face based on the second gaze information. The electronic device may detect a gaze at the inside of a monitor of the electronic device or another target in a space where the user is located, based on the second gaze information.

According to an example embodiment, even after correcting gaze information based on eye features of an individual, an allowable motion range of a user after the correction may not be limited to a specific position.

FIG. 7 is a diagram illustrating the acquisition of data on eyes features according to an example embodiment of the present disclosure.

A typical method of collecting data for gaze correction, which is used for an eye tracker and the like, may include capturing an image of a user gazing at a moving gaze target on a monitor screen in front of a monitor equipped with a camera, based on a rotation of eyes, without a large movement or rotation of a face of the user. In other words, by the typical method, gaze correction may not be available for angles beyond a physical range of the monitor screen.

However, unlike the typical method, a method of collecting training data for gaze correction, according to example embodiments of the present disclosure, may acquire training data beyond such a monitor screen. For example, it may collect the training data by iteratively performing a data collection process by moving the eyes slightly to the side by an eye rotation range required to gaze at a gaze target. This may allow the electronic device such as ones with small monitors (e.g., tablets and PCs) to readily build a data set for gaze correction in addition to pose information while minimizing movements of the user.

This method of acquiring a data set for gaze correction may be to acquire data on different rotation information of eyes of individuals required to gaze at a gaze target based on eye features of an individual.

As a result, compared to the typical deep learning-based gaze detection method, the method described herein according to example embodiments of the present disclosure may perform reliable gaze correction with only a small amount of data. This is because only rotation characteristics of the eyes gazing at a gaze target are corrected based on eye features of an individual, independent of a movement of a face. That is, during a training process for deep learning, the network 635 of FIG. 6 may not only detect generalized gaze information acquired through the analysis of face images of multiple users, but also additionally learn bias characteristics of a difference of the first unit vector caused by the users' unique eye features. In other words, the network 635 of FIG. 6 may be a network trained to detect generalized first gaze information and correct the generalized first gaze information based on eye features of a user.

Herein, the gaze correction may be performed by learning parameters of the network 635 to infer a gaze direction of a face in a training image for the gaze correction by using, as an input, feature values calculated up to a front network of the network 635 in response to training images for the gaze correction. In this case, meta-learning may be used, for example.

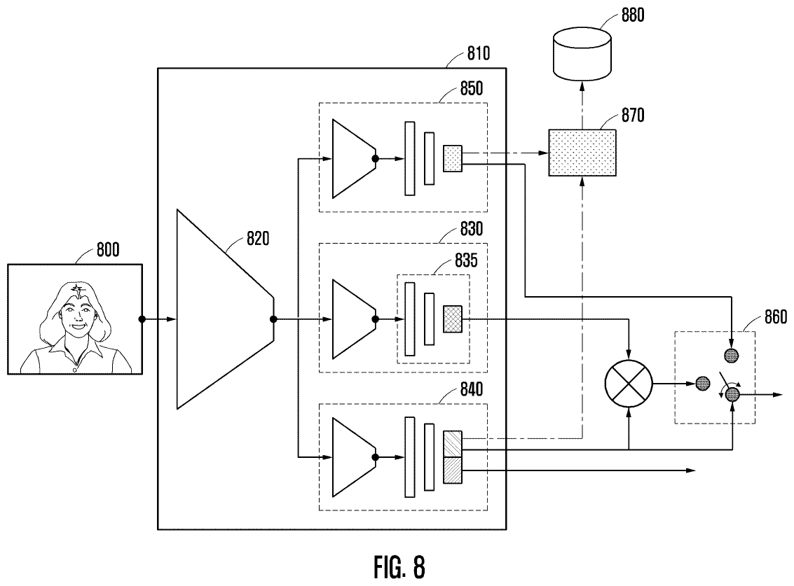

FIG. 8 is a diagram illustrating a deep learning network according to an example embodiment of the present disclosure.

Referring to FIG. 8, shown is a deep learning network 810 that receives, as an input, a normalized image 800 including a face of a user. The deep learning network 810 may include a backbone network 820 and may further include networks 830, 840, and 850 that output pose information and gaze information based on feature information output from the backbone network 820. However, the deep learning network 810 shown in FIG. 8 is provided only as an example, and example embodiments of the present disclosure are not limited thereto.

For detailed descriptions of the backbone network 820, the first network 830, and the second network 840, and a network 835 included in the first network 830, reference may be made to what has been described above with reference to FIGS. 6 and 7.

The deep learning network 810 may further include the third network 850. Based on the feature information extracted from the backbone network 820, the third network 850 may output third gaze information including a generalized unit vector from an origin of a facial coordinate system toward a gaze target, in a camera coordinate system. The third network 850 may include a network trained to detect generalized gaze information acquired by analyzing face images of multiple users in a deep learning process. In other words, the third gaze information may be gaze information that is not yet corrected based on eye features. Thus, the third gaze information may be more generalized information than first gaze information.

An electronic device may use the third gaze information to verify the reliability of the acquisition of data for gaze correction, provide complementary characteristics to a limited gaze correction range, and secure a gaze detection range over a wide area of motion of a user.

According to an example embodiment, the electronic device may further include a selector 860. The electronic device may use the selector 860 to select one from the third gaze information and fourth gaze information based on rotation information to determine the selected one as second gaze information. The fourth gaze information may include a personalized unit vector that is determined based on pose information and the first gaze information.

According to an example embodiment, the electronic device may use the selector 860 to determine the second gaze information by a weighted sum of the third gaze information and the fourth gaze information based on the rotation information. The fourth gaze information may include the personalized unit vector determined based on the pose information and the first gaze information. For example, the electronic device may assign a higher weight to the fourth gaze information when the image acquired through the camera is in a range of acquisition of data for gaze correction, based on the pose information. Conversely, the electronic device may assign a higher weight to the third gaze information when the image acquired through the camera is not in the range of acquisition of data for gaze correction, based on the pose information. This may allow the electronic device such as a tablet PC to naturally increase a personalized motion range, compared to a generalized motion range, as more data for gaze correction acquired from various user positions is accumulated over time.

The electronic device may further include a data selector 870 for selecting data for gaze correction. The data selector 870 may use the rotation information of the pose information and the generalized gaze information (i.e., the third gaze information) to determine whether a user is properly gazing at a gaze target at the time of acquiring data for gaze correction. The data selector 870 may determine the bias of data for gaze correction and determine the suitability of incoming data for gaze correction based on self-occlusion by a face rotation to select the data for gaze correction for the bias and availability to be used as training data for learning. The data acquired through the data selector 870 may be used to train a network (e.g., the network 735 of FIG. 7 and the network 835 of FIG. 8) for correcting generalized gaze information based on eye features of a person.

The data selector 870 may select the data for gaze correction and store it in a gaze correction data storage (e.g., memory).

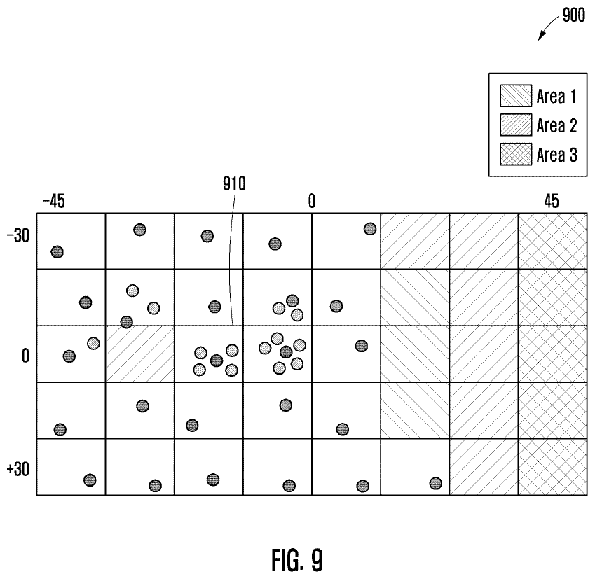

The operations of the data selector 870 will be described in detail below with reference to FIG. 9.

FIG. 9 is a diagram illustrating a method of selecting data according to an example embodiment of the present disclosure.

A data selector may be used to ensure that data to be acquired is not limited to a specific eye rotation range because, when detecting gaze information, as eye rotation directions are more evenly distributed to upward, downward, leftward, and rightward directions, better data is acquired and fits for the purpose of gaze correction.

The data selector may acquire an allowable pupil rotation range of a user. The electronic device may manage the data by dividing the allowable pupil rotation range into sections. In other words, the data selector may manage the data using a table 900 in which the allowable pupil rotation range is divided into sections. For example, the data selector may manage the data using the table 900 in which an allowable pupil rotation range of 30 degrees (°) in an up-down direction and 45° in a left-right direction into sections. The table 900 may include a plurality of areas divided into sections.

According to an example embodiment, the data selector may manage a degree of bias by assigning a weight to areas from which no data for gaze correction is collected. For example, the data selector may assign the highest weight to area 1. The data selector may assign the second highest weight to area 2 after area 1. The data selector may assign the lowest weight to area 3. The data selector may minimize the degree of bias by preferentially presenting a gaze target corresponding to an area from which data is not acquired despite a high weight, when collecting the data for gaze correction, and by collecting the data accordingly.

According to an example embodiment, data may be collected redundantly for one area such as an area 910. The data selector may manage the redundant data by selecting or deleting data based on self-occlusion in an acquired image or reliability of facial pose information, and data learning suitability such as eye features, using facial pose information collected together with the data when the data is acquired.

Thus, the data selector may recognize a natural gazing situation that may occur when a user uses various services and continuously select and collect data for gaze correction.

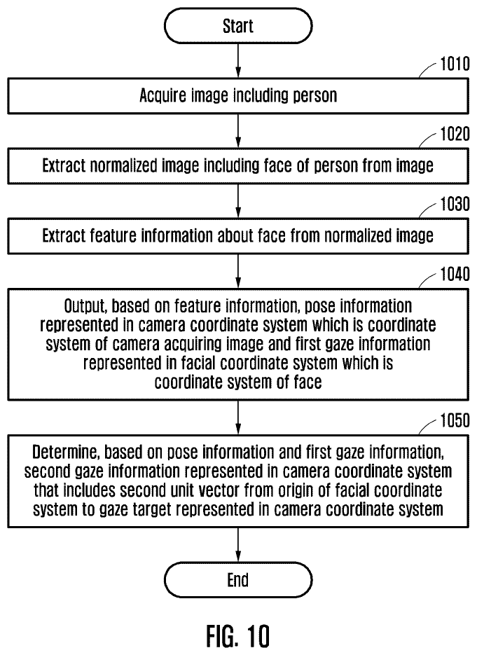

FIG. 10 is a flowchart illustrating an operating method of an electronic device according to an example embodiment of the present disclosure.

According to an example embodiment, operations described below may be performed sequentially but may not be necessarily performed sequentially. For example, the order of the operations may be changed, and at least two of the operations may be performed in parallel. Operation 1010 to operation 1050 may be performed by at least one component (e.g., the host processor of FIG. 1 and the accelerator of FIG. 1) of an electronic device.

At operation 1010, the electronic device may acquire an image including a person.

At operation 1020, the electronic device may extract a normalized image including a face of the person from the image.

At operation 1030, the electronic device may extract feature information about the face from the normalized image.

At operation 1040, the electronic device may output, based on the feature information, pose information represented in a camera coordinate system which is a coordinate system of a camera acquiring the image and first gaze information represented in a facial coordinate system which is a coordinate system of the face.

At operation 1050, the electronic device may determine, based on the pose information and the first gaze information, second gaze information represented in the camera coordinate system that includes a second direction vector from an origin of the facial coordinate system to a gaze target represented in the camera coordinate system.

For a more detailed description of the operations shown in FIG. 10, reference may be made to what has been described above with reference to FIGS. 1 through 9.

According to an example embodiment of the present disclosure, stable gaze correction may be performed using a small number of training data for gaze correction. According to an example embodiment, a combined operation of a generalized gaze detection method and a personalized gaze detection method may be applied to provide stable and accurate gaze detection based on eye features of individual users without a limitation of an allowable motion or movement range of a user.

Therefore, it may detect a gaze of a user without restricting a movement of the user or requiring the user to wear a special device, and may be applied in various fields such as interest analysis, concentration analysis, abnormal behavior detection, and contactless user experience.

For example, the gaze detection method of example embodiments of the present disclosure may be used to detect a gaze of a user in front of a camera, using a camera installed on an electronic device such as an information kiosk, an advertising display, and an information-providing tablet. The detected gaze of the user may be used to analyze, in real time, interest or concentration on the content, advertisement, information, and the like being provided, and to provide user-customized content services or provide various screen configurations for maintaining concentration.

For example, the gaze detection method of example embodiments of the present disclosure may be applied to a digital human introduced in a kiosk system or the like to stimulate the interest or concentration of a user or to make natural eye contact with a face of the user.

For example, the gaze detection method of example embodiments of the present disclosure may be used in a contactless user command recognition system and the like for patients with limited mobility or the elderly. The gaze detection method of example embodiments of the present disclosure may also be used in various types of contactless user command recognition systems that may dispose cameras and monitors in front of the faces of patients who are unable to use their hands and detect the gazes of the patients to perform certain commands on the monitors in a contactless manner, or may recognize a specific gaze target in a space to call a nurse if necessary.

For example, the gaze detection method of example embodiments of the present disclosure may also be used in consumer electronics such as refrigerators and TVs, various smart devices, vehicle infotainment, or the like to recognize a precise gaze direction of a user and perform commands or provide various customized services.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine-readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor may receive instructions and data from a read-only memory or a random-access memory, or both. Elements of a computer may include at least one processor for executing instructions and one or more memory devices for storing instructions and data. Generally, a computer may also include, or be operatively coupled, to receive data from or transfer data to, or both, one or more mass storage devices for storing data, e.g., magnetic, magneto-optical disks, or optical discs. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in, special-purpose logic circuitry.

In addition, non-transitory computer-readable media may be any available media that may be accessed by a computer and may include both computer storage media and transmission media.

Although the present disclosure includes details of a plurality of specific example embodiments, the details should not be construed as limiting any invention or a scope that can be claimed, but rather should be construed as being descriptions of features that may be unique to specific example embodiments of specific inventions. Specific features described in the present disclosure in the context of individual example embodiments may be combined and implemented in a single example embodiment. On the contrary, various features described in the context of a single example embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or that all the shown operations must be performed in order to acquire a preferred result. In some specific cases, multitasking and parallel processing may be advantageous. In addition, it should not be understood that the separation of various device components of the aforementioned example embodiments is required for all the example embodiments, and it should be understood that the aforementioned program components and devices may be integrated into a single software product or packaged into multiple software products.

The example embodiments described in the present disclosure and the drawings are intended merely to present specific examples in order to aid in understanding of the present disclosure but are not intended to limit the scope of the present disclosure. It will be apparent to those skilled in the art that various modifications based on the technical spirit of the present disclosure, as well as the disclosed example embodiments, can be made.

What is claimed is:

1. An operating method of an electronic device, comprising:
acquiring an image comprising a person;
extracting a normalized image comprising a face of the person from the image;
extracting feature information about the face from the normalized image;
outputting, based on the feature information, pose information represented in a camera coordinate system which is a coordinate system of a camera acquiring the image and first gaze information represented in a facial coordinate system which is a coordinate system of the face; and
determining, based on the pose information and the first gaze information, second gaze information represented in the camera coordinate system that comprises a second unit vector from an origin of the facial coordinate system toward a gaze target represented in the camera coordinate system,
wherein the pose information comprises:
rotation information and position information about the face,
wherein the first gaze information comprises:
a first unit vector represented by a rotation of eyes from the origin of the facial coordinate system toward the gaze target, in the facial coordinate system.

2. The operating method of claim 1, wherein the outputting of the pose information represented in the camera coordinate system and the first gaze information represented in the facial coordinate system based on the feature information comprises:
outputting the first gaze information based on the feature information and on a network that is trained to detect generalized first gaze information and correct the generalized first gaze information based on features of the eyes of the person.

3. The operating method of claim 1, wherein the first gaze information comprises:
the first unit vector that is corrected based on features of the eyes of the person to be personalized for the person.

4. The operating method of claim 1, wherein the second gaze information comprises:
the second unit vector that is personalized for the person as features of the eyes of the person are reflected.

5. The operating method of claim 1, further comprising:
identifying a position of the face from the position information, and detecting the gaze target along the second gaze information from the position of the face.

6. The operating method of claim 1, further comprising:
outputting, based on the feature information, third gaze information comprising a generalized third unit vector from the origin of the facial coordinate system toward the gaze target, in the camera coordinate system.

7. The operating method of claim 6, wherein the determining of the second gaze information comprises:
selecting, based on the rotation information, one from the third gaze information and fourth gaze information comprising a personalized unit vector determined based on the pose information and the first gaze information, and determining the selected one to be the second gaze information.

8. The operating method of claim 6, wherein the determining of the second gaze information comprises:
determining the second gaze information by a weighted sum of the third gaze information and fourth gaze information, based on the rotation information,
wherein the fourth gaze information comprises:
a personalized unit vector determined based on the pose information and the first gaze information.

9. The operating method of claim 6, further comprising:
acquiring data for training a network configured to correct generalized first gaze information based on features of the eyes of the person.

10. The operating method of claim 9, wherein the acquiring of the data comprises:
acquiring the third gaze information as the data by generating a plurality of areas for a pupil rotation range of the person based on the features of the eyes, and acquiring the data preferentially by assigning a weight to an area from which data is not acquired among the plurality of areas.

11. The operating method of claim 10, wherein the acquiring of the data comprises:
for areas from which data is acquired redundantly among the plurality of areas, selecting one from the redundantly acquired data based on the features of the eyes.

12. An operating method of an electronic device, comprising:
acquiring an image comprising a person;
extracting a normalized image comprising a face of the person from the image;
extracting feature information about the face from the normalized image;
outputting, based on the feature information, pose information represented in a camera coordinate system which is a coordinate system of a camera acquiring the image and first gaze information represented in a facial coordinate system which is a coordinate system of the face;
outputting, based on the feature information, second gaze information represented in the camera coordinate system that comprises a generalized unit vector from an origin of the facial coordinate system of the person toward a gaze target represented in the camera coordinate system; and
determining third gaze information comprising a third unit vector from the origin of the facial coordinate system toward the gaze target, in the camera coordinate system, based on the pose information, the first gaze information, and the second gaze information,
wherein the pose information comprises:
rotation information and position information about the face,
wherein the first gaze information comprises:
a first unit vector represented by a rotation of eyes from the origin of the facial coordinate system toward the gaze target, in the facial coordinate system.

13. A non-transitory computer-readable storage medium storing instructions that, when executed by a processor, cause the processor to perform the operating method of claim 1.

14. An electronic device, comprising:
a processor configured to acquire an image comprising a person; extract a normalized image comprising a face of the person from the image; extract feature information about the face from the normalized image; output, based on the feature information, pose information represented in a camera coordinate system which is a coordinate system of a camera acquiring the image and first gaze information represented in a facial coordinate system which is a coordinate system of the face; and determine, based on the pose information and the first gaze information, second gaze information represented in the camera coordinate system that comprises a second unit vector from an origin of the facial coordinate system toward a gaze target represented in the camera coordinate system,
wherein the pose information comprises:
rotation information and position information about the face,
wherein the first gaze information comprises:
a first unit vector represented by a rotation of eyes from the origin of the facial coordinate system toward the gaze target, in the facial coordinate system.

15. The electronic device of claim 14, wherein the processor is configured to:
output the first gaze information based on the feature information and on a network that is trained to detect generalized first gaze information and correct the generalized first gaze information based on features of the eyes of the person.

16. The electronic device of claim 14, wherein the first gaze information comprises:
the first unit vector that is corrected based on features of the eyes of the person to be personalized for the person.

17. The electronic device of claim 14, wherein the second gaze information comprises:
the second unit vector that is personalized for the person as features of the eyes of the person are reflected.

18. The electronic device of claim 14, wherein the processor is configured to:
identify a position of the face from the position information, and detect the gaze target along the second gaze information from the position of the face.

19. The electronic device of claim 14, wherein the processor is configured to:
output, based on the feature information, third gaze information comprising a generalized unit vector from the origin of the facial coordinate system toward the gaze target, in the camera coordinate system.

20. The electronic device of claim 19, being configured to:
select, based on the rotation information, one from the third gaze information and fourth gaze information comprising a personalized unit vector determined based on the pose information and the first gaze information, and determine the selected one to be the second gaze information.
